(19) United States
(12) Patent Application Publication
(10) Pub. No.: US 2006/0293183 A1
(43) Pub. Date: Dec. 28, 2006

(54) Direct thermographic materials with dual protective layers

(75) Inventors: Raymond J. Kenney, Woodbury, MN (US); David G. Baird, Woodbury, MN (US); Thomas J. Kub, North Stillwater, MN (US); Takuzo Ishida, Woodbury, MN (US); William D. Ramsden, Afton, MN (US)

Correspondence Address: Paul A. Leipold;Eastman Kodak Company, Patent Legal Staff, 343 State Street, Rochester, NY, 14650-2201, US

(73) Assignee: Eastman Kodak Company

(21) Appl. No.: 11/166,309

(22) Filed: Jun. 24, 2005

(51) Int. Cl. B41M 5/20

(52) U.S. Cl. 503/212

(57) ABSTRACT

A direct thermographic material has one or more thermographic layers on a polymeric support. Two protective layers are disposed over the one or more thermographic layers and both protective layers comprise the same polymer as the predominant binder. The outermost protective layer contains one or more lubricants while the innermost protective layer is substantially free of lubricants.

### FIELD OF THE INVENTION

This invention relates to non-photosensitive thermographic materials, particularly black-and-white thermographic materials, having two protective layers disposed over the thermographic layers. The invention also relates to methods of imaging such direct thermographic materials.

### BACKGROUND OF THE INVENTION

Silver-containing direct thermographic imaging materials are non-photosensitive materials that are used in a recording process wherein images are generated by the direct application of thermal energy and in the absence of a processing solvent. These materials have been known in the art for many years and generally comprise a support having disposed thereon one or more imaging layers comprising (a) a relatively or completely non-photosensitive source of reducible silver ions, (b) a reducing agent composition (acting as a black-and-white silver developer) for the reducible silver ions, and (c) a suitable binder. Thermographic materials are sometimes called “direct thermal” materials in the art because they are directly imaged by a source of thermal energy without any transfer of the image or image-forming materials to another element (such as in thermal dye transfer).

In a typical thermographic construction, the image-forming thermographic layers comprise silver salts of long chain fatty acids. A preferred non-photosensitive reducible silver source is a silver salt of a long chain aliphatic carboxylic acid having from 10 to 30 carbon atoms, such as behenic acid or mixtures of acids of similar molecular weight. At elevated temperatures, the silver of the silver carboxylate is reduced by a reducing agent (also known as a developer), whereby elemental silver is formed. Imagewise heating, such as by using a thermal print-head, results in a black-and-white image.

### PROBLEM TO BE SOLVED

As noted above, direct thermographic materials are imaged by a recording process whereby images are generated by imagewise heating a recording material containing chemical components that change color or optical density in an imagewise fashion. Such materials generally include one or more thermographic (imaging) layers on a polymeric support. Imaging is generally carried out using a thermal imaging means such as a thermal print-head in direct contact with the imaging side of the material. In order to protect the imaging chemistry during imaging, the materials generally include an outermost protective (or topcoat) layer that is designed with lubricants and matte particles to enable smooth transport with minimal debris formation and scratching during imaging. Such protective layers are known as transport or “slip” layers. Debris or defects in the outermost layer can cause intermittent transport resulting in alternating light and dark bands, one form of image defect.

U.S. Pat. No. 5,817,598 (Defieuw et al.) describes thermographic materials with outermost layers containing lubricants and matte agents to provide a dynamic coefficient of friction of less than 0.3 during contact with the thermal imaging means.

Other direct thermographic materials include both protective layers and barrier layers that inhibit the diffusion of chemical reactants or by-products from the imaging layers to the outermost surface. EP 1,431,059 (Geuens et al.) describes “comparative” direct thermographic materials having outermost protective layers and inner barrier layers containing polyvinyl alcohol. Other described materials have an outermost polyvinyl alcohol protective layer and an inner cellulose acetate butyrate barrier layer. High loading of the outermost protective layer with lubricants and matte particles, however, can increase haze and debris during imaging.

There remains a need, however, for improved “slip” properties in the outermost layers of direct thermographic materials to provide continuous transport without an increase in haze, formation of debris, or imaging defects.

### SUMMARY OF THE INVENTION

This invention provides a direct thermographic material comprising a polymeric support and having thereon one or more thermographic layers, and disposed over the one or more thermographic layers, first and second protective layers comprising the same organic solvent soluble polymer other than polyvinyl alcohol as the predominant binder, the first protective layer being farther from the support than the second protective layer, and the first protective layer comprising one or more lubricants while the second protective layer is substantially free of lubricants.

In preferred embodiments, a black-and-white direct thermographic material comprises a polyester support and has on only one side thereof:

a thermographic layer comprising a non-photosensitive source of reducible silver ions that includes at least highly crystalline silver behenate and a reducing agent for producing a silver image, all distributed in a film-forming polyvinyl acetal, polyvinyl butyral, or cellulosic polymer binder,

disposed directly over the thermographic layer, first and second protective layers comprising cellulose acetate butyrate as the predominant binder, the first protective layer being farther from the support than the second protective layer, and the first protective layer comprising one or more lubricants and matte particles while the second protective layer is substantially free of lubricants, and the first protective layer is the outermost layer,

wherein the first protective layer has a dry thickness of from about 0.3 to about 3 μm and the second protective layer has a dry thickness of from about 0.5 to about 4 μm, and the ratio of dry thickness of the first protective layer to the second protective layer is from about 1:10 to about 2:1.

This invention also provides a method for preparing a direct thermographic material comprising:

A) applying one or more thermographic formulations onto a polymeric support to provide one or more thermographic layers, and

B) applying over the one or more thermographic layers, first and second protective layer formulations comprising the same organic solvent soluble polymer other than polyvinyl alcohol as the predominant binder, to provide first and second protective layers, the first protective layer being farther from the support than the second protective layer, and the first protective layer comprising one or more lubricants while the second protective layer is substantially free of lubricants.

This invention also provides a method of providing a visible image comprising imaging the direct thermographic material of the invention with a thermal imaging source. The resulting visible image can be used for medical diagnosis, among other uses.

We have found an improvement in thermographic materials by providing dual protective layers over the thermographic layers. The lubricants, matte agents, and other components desired to facilitate transport are located in the outermost (or “first”) protective layer while the innermost (or “second”) protective layer is essentially free of lubricants and matte agents. Locating the lubricants in the outermost layer allows less lubricant to be used and still achieve the desired “slip” properties.

### DETAILED DESCRIPTION OF THE INVENTION

The direct thermographic materials can be used to provide black-and-white silver images using non-photosensitive silver salts, reducing agents, binders, and other components known to be useful in such materials.

The direct thermographic materials can be used in black-and-white thermography and in electronically generated black-and-white hardcopy recording. They can be used as output media, in radiographic imaging (for example digital medical imaging), X-ray radiography, and in industrial radiography. Furthermore, the absorbance of these thermographic materials between 350 and 450 nm is desirably low (less than 0.5), to permit their use in the graphic arts area (for example, in imagesetting and phototypesetting operations), in the manufacture of printing plates, in contact printing, in duplicating (“duping”), and in proofing.

The direct thermographic materials are particularly useful as output media for medical imaging of human or animal subjects in response to visible or X-radiation for diagnostic purposes. Such applications include, but are not limited to, thoracic imaging, mammography, dental imaging, orthopedic imaging, general medical radiography, therapeutic radiography, veterinary radiography, and auto-radiography.

In direct thermographic materials, the components needed for imaging can be in one or more thermally sensitive or thermographic layers on one side (“frontside”) of the support. The layer(s) that contain the non-photosensitive source of reducible silver ions, or both, are referred to herein as thermographic, emulsion, or thermally sensitive imaging layer(s).

Where the materials contain thermographic imaging layers on one side of the support only, various non-imaging layers can be disposed on the “backside” (non-emulsion or non-imaging side) of the materials, such as primer layers, interlayers, opacifying layers, subbing layers, carrier layers, auxiliary layers and/or conductive layers. Particularly important non-imaging layers include a conductive layer and an outermost protective layer.

In such embodiments, various non-imaging layers can also be disposed on the “frontside,” imaging, or emulsion side of the support, including primer layers, interlayers, opacifying layers, subbing layers, auxiliary layers, carrier layers, and other layers readily apparent to one skilled in the art.

In some embodiments, the direct thermographic materials are “double-sided” and have thermographic imaging layer(s) on both sides of the support. In such constructions, each side can also include one or more carrier layers, primer layers, adhesive layers, interlayers, antistatic or conductive layers, auxiliary layers, and other layers readily apparent to one skilled in the art. The first and second protective layers described below can be on either or both sides of the support.

Definitions

As used herein:

In the descriptions of the thermographic materials, “a” or “an” component refers to “at least one” of that component (for example, the reducing agents described below).

The term “black-and-white” refers to an image formed by silver metal.

“Thermographic material(s)” means a dry processable integral construction comprising at least one thermographic emulsion layer or a set of emulsion layer(s) (wherein the source of reducible silver ions is in one layer and other components or additives are distributed, as desired, in the same layer or in an adjacent coated layer), as well as any support, first and second protective layers, carrier layer, conductive layers, and subbing or priming layers. These materials also include multilayer constructions in which one or more imaging components are in different thermographic layers, but are in “reactive association.” For example, one layer can include the non-photosensitive source of reducible silver ions and another layer can include the reducing agent, but the two reactive components are in reactive association with each other. By “integral” we mean that all imaging chemistry required for imaging is in the material without diffusion of the imaging chemistry or reaction products (such as a dye) from or to another element (such as a receiver element).

Also, unless otherwise indicated, the terms “thermographic material” and “direct thermographic material” are meant to refer to embodiments of the present invention.

When used in thermography, the term, “imagewise exposing” or “imagewise exposure” means that the material is imaged using any means that provides an image using heat. This includes, for example, analog exposure where an image is formed by differential contact heating through a mask using a thermal blanket or infrared heat source, as well as by digital exposure where the image is formed one pixel at a time such as by modulation of thermal print-heads or by thermally imaging with a modulated scanning laser beam. The direct thermo-graphic materials described herein are preferably imaged using a digital exposure.

The “direct” thermographic materials are thermally imaged as a single element containing all of the necessary imaging chemistry. Direct thermal imaging is distinguishable from what is known in the art as thermal transfer imaging (such as dye transfer imaging) in which the image is produced in one material (“donor”) and transferred to another material (“receiver”) using thermal means.

“Catalytic proximity” or “reactive association” means that the reactive components are in the same layer or in adjacent layers so that they readily come into contact with each other during thermal imaging and development.

“Emulsion layer,” “imaging layer,” or “thermographic emulsion layer,” means a thermally sensitive layer of a thermographic material that contains at least the non-photosensitive source of reducible silver ions or a reducing agent. It can also mean a layer of the thermographic material that contains, in addition to the non-photosensitive source of reducible silver, additional desirable components. These layers are usually on what is known as the “frontside” of the support.

“Non-photosensitive” means not intentionally light sensitive. The direct thermographic materials described herein are non-photosensitive meaning that no photosensitive silver halide(s) has been purposely added or created.

“Simultaneous coating” or “wet-on-wet” coating means that when multiple layers are coated, subsequent layers are coated onto the initially coated layer before the initially coated layer is dry.

The sensitometric terms, absorbance, contrast, Dmin, and Dmax have conventional definitions known in the imaging arts. In thermographic materials, Dmin is considered herein as image density in the areas with the minimum application of heat by the thermal print-head. The term Dmax is the maximum image density achieved when the thermographic material is thermally imaged with a given amount of thermal energy. The sensitometric term absorbance is another term for optical density (OD).

Image tone is defined by the known CIELAB color system (Commission Internationale de l'Eclairage) as discussed in detail in Principles of Color Technology, 2^{nd} Ed., Billmeyer and Saltzman, John Wiley & Sons, 1981. In this color system, color space is defined in terms of L*, a*, and b* wherein L* is a measure of the luminance or lightness of a given color, a* is a measure of the red-green contribution, and b* is a measure of the yellow-blue contribution. In a two-dimension plot of a* versus b*, a more negative a* provides a greener tone and a more negative b* provides a bluer tone. Conversely, a more positive a* provides a more reddish tone and a more positive b* provides a more yellowish tone. Neutral tone is defined wherein a* and b* are both zero. In black-and-white thermography, as optical density increases, a* and b* tend toward zero. Image tone values a* and b* can be measured using conventional methods and equipment, such as a HunterLab UltraScan Colorimeter. In thermographic materials it is preferred to have a “colder” image with a negative a* (green) and a negative b* (blue).

“Transparent” means capable of transmitting visible light or imaging radiation without appreciable scattering or absorption.

The phrases “silver salt” and “organic silver salt” refer to an organic molecule having a bond to a silver atom. Although the compounds so formed are technically silver coordination complexes or silver compounds they are also often referred to as silver salts.

The terms “double-sided,” “double-faced coating,” and “duplitized” are used to define thermographic materials having one or more of the same or different thermographic layers and first and second protective layers disposed on both sides (frontside and backside) of the support.

As is well understood in this art, for the chemical compounds herein described, substitution is not only tolerated, but is often advisable and various substituents are anticipated on the compounds used in the present invention unless otherwise stated. Thus, when a compound is referred to as “having the structure” of a given formula, any substitution that does not alter the bond structure of the formula or the shown atoms within that structure is included within the formula, unless such substitution is specifically excluded by language (such as “free of carboxy-substituted alkyl”).

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. For example, alkyl group can include ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art. A skilled artisan would exclude substituents that adversely react with other active ingredients as not being inert or harmless.

Research Disclosure (http:H/www.researchdisclosure.com) is a publication of Kenneth Mason Publications Ltd., The Book Barn, Westbourne, Hampshire PO10 8RS, UK. It is also available from Emsworth Design Inc., 200 Park Avenue South, Room 1101, New York, N.Y. 10003.

Other aspects, advantages, and benefits of the present invention are apparent from the detailed description, examples, and claims provided in this application.

Non-Photosensitive Source of Reducible Silver Ions

The non-photosensitive source of reducible silver ions used in the direct thermographic materials can be any silver-organic compound that contains reducible silver (I) ions. Such compounds are generally silver salts of silver coordinating ligands. Preferably, it is an organic silver salt that is comparatively stable to light and forms a silver image when heated to 50° C. or higher in the presence of a reducing agent. Mixtures of the same or different types of silver salts can be used if desired.

Suitable organic silver salts include silver salts of organic compounds having a carboxylic acid group. Examples thereof include silver salts of aliphatic and aromatic carboxylic acids. Silver salts of long-chain aliphatic carboxylic acids are preferred. The chains typically contain 10 to 30, and preferably 15 to 28, carbon atoms. Preferred examples of the silver salts of aliphatic carboxylic acids include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Preferably, silver behenate is used alone or in mixtures with other silver salts.

In some embodiments, a highly crystalline silver behenate can be used as part or all of the non-photosensitive sources of reducible silver ions that includes one or more silver carboxylates, as described in U.S. Pat. No. 6,096,486 (Emmers et al.) and U.S. Pat. No. 6,159,667 (Emmers et al.), both incorporated herein by reference. Moreover, the silver behenate can be used in its one or more crystallographic phases (such as a mixture of phases I, II and/or III) as described in U.S. Pat. No. 6,677,274 (Geuens et al.) that is incorporated herein by reference.

Other useful but less preferred silver salts include but are not limited to, silver salts of aromatic carboxylic acids and other carboxylic acid group-containing compounds, silver salts of aliphatic carboxylic acids containing a thioether group as described in U.S. Pat. No. 3,330,663 (Weyde et al.), silver carboxylates comprising hydrocarbon chains incorporating ether or thioether linkages, or sterically hindered substitution in the α- (on a hydrocarbon group) or ortho- (on an aromatic group) position, as described in U.S. Pat. No. 5,491,059 (Whitcomb), silver salts of aliphatic, aromatic, or heterocyclic dicarboxylic acids, silver salts of sulfonates as described in U.S. Pat. No. 4,504,575 (Lee), silver salts of sulfosuccinates as described in EP 0 227 141 A1 (Leenders et al.), silver salts of acetylenes as described in U.S. Pat. No. 4,761,361 (Ozaki et al.) and U.S. Pat. No. 4,775,613 (Hirai et al.), silver salts of compounds containing mercapto or thione groups and derivatives thereof (such as those having a heterocyclic nucleus containing 5 or 6 atoms in the ring, at least one of which is a nitrogen atom), as described in U.S. Pat. No. 4,123,274 (Knight et al.) and U.S. Pat. No. 3,785,830 (Sullivan et al.), silver salts of mercapto or thione substituted compounds that do not contain a heterocyclic nucleus, silver salts of compounds containing an amino group (such as silver salts of benzotriazole and substituted derivatives thereof), silver salts of 1,2,4-triazoles or 1-H-tetrazoles as described in U.S. Pat. No. 4,220,709 (deMauriac), and silver salts of imidazole and imidazole derivatives as described in U.S. Pat. No. 4,260,677 (Winslow et al.).

It is also convenient to use silver half soaps that are blends of silver carboxylates and carboxylic acids each having from 10 to 30 carbon atoms, and preferably from 15 to 28 carbon atoms.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.), and the references cited above.

Non-photosensitive sources of reducible silver ions can also be provided as core-shell silver salts such as those described in U.S. Pat. No. 6,355,408 (Whitcomb et al.), or as silver dimer compounds that comprise two different silver salts as described in U.S. Pat. No. 6,472,131 (Whitcomb), both of which are incorporated herein by reference.

The one or more non-photosensitive sources of reducible silver ions are preferably present in an amount of from about 5% to about 70% (more preferably, from about 10% to about 50%), based on the total dry weight of the emulsion layers. Stated another way, the amount of the sources of reducible silver ions is generally present in an amount of from about 0.001 to about 0.2 mol/m of the thermographic material, and preferably from about 0.005 to about 0.05 mol/m² of that material.

Reducing Agents

The direct thermographic materials include one or more reducing agents (of the same or different types) to reduce the silver ions during imaging. Such reducing agents are well known to those skilled in the art and include, for example, aromatic di- and tri-hydroxy compounds having at least two hydroxy groups in ortho- or para-relationship on the same aromatic nucleus such as hydroquinone and substituted hydroquinones, catechols, pyrogallol, gallic acid and gallic acid esters (for example, methyl gallate, ethyl gallate, propyl gallate), and tannic acid.

Particularly preferred are catechol-type reducing agents having no more than two hydroxy groups in an ortho-relationship.

One particularly preferred class of catechol-type reducing agents are benzene compounds in which the benzene nucleus is substituted by no more than two hydroxy groups which are present in 2,3-position on the nucleus and have in the 1-position of the nucleus a substituent linked to the nucleus by means of a carbonyl group. Compounds of this type include 2,3-dihydroxy-benzoic acid, and 2,3-dihydroxy-benzoic acid esters (such as methyl 2,3-dihydroxy-benzoate, and ethyl 2,3-dihydroxy-benzoate).

Another particularly preferred class of catechol-type reducing agents are benzene compounds in which the benzene nucleus is substituted by no more than two hydroxy groups which are present in 3,4-position on the nucleus and have in the 1-position of the nucleus a substituent linked to the nucleus by means of a carbonyl group. Compounds of this type include, for example, 3,4-dihydroxy-benzoic acid, 3-(3,4-dihydroxy-phenyl)-propionic acid, 3,4-dihydroxy-benzoic acid esters (such as methyl 3,4-dihydroxy-benzoate, and ethyl 3,4-dihydroxy-benzoate), 3,4-dihydroxy-benzaldehyde, and phenyl-(3,4-dihydroxyphenyl)ketone. 3,4-Dihydroxybenzonitrile is also useful. Such compounds are described, for example, in U.S. Pat. No. 5,582,953 (Uyttendaele et al.) that is incorporated herein by reference.

Mixtures of catechol reducing agents with various substituents can be used to optimize reactivity, Dmax, Dmin, and other imaging properties of the thermographic material.

Still another particularly useful class of reducing agents are the polyhydroxy spiro-bis-indane compounds that are described in U.S. Pat. No. 3,440,049 (Moede) and U.S. Pat. No. 5,817,598 (Defieuw et al.), both incorporated herein by reference.

In some constructions, “hindered phenol reducing agents” can be used. “Hindered phenol reducing agents” are compounds that contain only one hydroxy group on a given phenyl ring and have at least one additional substituent located ortho to the hydroxy group.

One type of hindered phenol includes hindered phenols and hindered naphthols.

Another type of hindered phenol reducing agents are hindered bis-phenols. These compounds contain more than one hydroxy group each of which is located on a different phenyl ring. This type of hindered phenol includes, for example, binaphthols (that is dihydroxybinaphthyls), biphenols (that is dihydroxybiphenyls), bis(hydroxynaphthyl)methanes, bis(hydroxyphenyl)-methanes bis(hydroxyphenyl)ethers, bis(hydroxyphenyl)sulfones, and bis(hydroxyphenyl)thioethers, each of which may have additional substituents.

Preferred hindered phenol reducing agents are bis(hydroxyphenyl)-methanes such as, bis(2-hydroxy-3-t-butyl-5-methylphenyl)methane (CAO-5), 1,1′-bis(2-hydroxy-3,5-dimethylphenyl)-3,5,5-trimethylhexane (NONOX® or PERMANAX® WSO), and 1,1′-bis(2-hydroxy-3,5-dimethylphenyl)isobutane (LOWINOX® 22IB46) Mixtures of hindered phenol reducing agents can be used if desired.

Further reducing agents include certain ortho-amino-phenol, para-amino-phenol, and hydroquinone (that is, para-hydroxy-phenol) compounds described in copending and commonly assigned U.S. Ser. No. 11/012,788 (filed Dec. 15, 2004 by Whitcomb, Olson, Cowdery-Corvan, Sakizadeh, and Ishida) that is incorporated herein by reference.

The reducing agent (or mixture thereof) described herein is generally present in an amount greater than 0.1 mole per mole of silver and at 1 to 10% (dry weight) of the emulsion layer. In multilayer constructions, if the reducing agent is added to a layer other than an emulsion layer, slightly higher proportions, of from about 2 to 15 weight % may be more desirable. Any co-developers may be present generally in an amount of from about 0.001% to about 1.5% (dry weight) of the emulsion layer coating.

Stated another way, the reducing agents described herein can be present in an amount of at least 0.03 mol/mol of total silver. Preferably, they are present in an amount of from about 0.05 to about 2 mol/mol of total silver. The total amount of silver in the thermographic materials is at least 3 mmol/m² and preferably from about 6 to about 12 mmol/m².

Other Addenda

The direct thermographic materials can also contain other additives such as toners, shelf-life stabilizers, contrast enhancers, dyes or pigments, post-processing stabilizers or stabilizer precursors, thermal solvents (also known as melt formers), and other image-modifying agents as would be readily apparent to one skilled in the art.

Suitable stabilizers that can be used alone or in combination include thiazolium salts as described in U.S. Pat. No. 2,131,038 (Staud) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles described in U.S. Pat. No. 3,287,135 (Anderson), sulfocatechols as described in U.S. Pat. No. 3,235,652 (Kennard), the oximes described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), compounds having —SO₂CBr₃ groups as described in U.S. Pat. No. 5,369,000 (Sakizadeh et al.), U.S. Pat. No. 5,464,747 (Sakizadeh et al.) U.S. Pat. No. 5,594,143 (Kirk et al.), U.S. Pat. No. 5,374,514 (Kirk et al.), and U.S. Pat. No. 5,460,938 (Kirk et al.).

Stabilizer precursor compounds capable of releasing stabilizers upon application of heat during imaging can also be used, as described in U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

In addition, certain substituted-sulfonyl derivatives of benzo-triazoles may be used as stabilizing compounds as described in U.S. Pat. No. 6,171,767 (Kong et al.).

“Toners” or derivatives thereof that improve the image are desirable components of the thermographic materials. These compounds, when added to the imaging layer, shift the color of the image from yellowish-orange to brown-black or blue-black. Generally, one or more toners described herein are present in an amount of from about 0.01% to about 10% (more preferably from about 0.1% to about 10%), based on the total dry weight of the layer in which the toner is included. Toners may be incorporated in the thermographic layer or in an adjacent non-imaging layer.

Compounds useful as toners are described in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), U.S. Pat. No. 5,599,647 (Defieuw et al.) and GB 1,439,478 (AGFA).

Additional useful toners are substituted and unsubstituted mercaptotriazoles as described in U.S. Pat. No. 3,832,186 (Masuda et al.), U.S. Pat. No. 6,165,704 (Miyake et al.), U.S. Pat. No. 5,149,620 (Simpson et al.), U.S. Pat. No. 6,713,240 (Lynch et al.), and U.S. Pat. No. 6,841,343 (Lynch et al.), all of which are incorporated herein by reference.

Phthalazine and phthalazine derivatives [such as those described in U.S. Pat. No. 6,146,822 (Asanuma et al.), incorporated herein by reference], phthalazinone, and phthalazinone derivatives are particularly useful toners.

A combination of one or more hydroxyphthalic acids and one or more phthalazinone compounds can be included in the thermographic materials. Hydroxyphthalic acid compounds have a single hydroxy substituent that is in the meta position to at least one of the carboxy groups. Preferably, these compounds have a hydroxy group in the 4-position and carboxy groups in the 1- and 2-positions. The hydroxyphthalic acids can be further substituted in other positions of the benzene ring as long as the substituents do not adversely affect their intended effects in the thermographic material. Mixtures of hydroxyphthalic acids can be used if desired.

Useful phthalazinone compounds are those having sufficient solubility to completely dissolve in the formulation from which they are coated. Preferred phthalazinone compounds include 6,7-dimethoxy-1-(2H)-phthalazinone, 4-(4-pentylphenyl)-1-(2H)-phthalazinone, and 4-(4-cyclohexylphenyl)-1-(2H)-phthalazinone. Mixtures of such phthalazinone compounds can be used if desired.

This combination facilitates obtaining a stable bluish-black image after processing. In preferred embodiments, the molar ratio of hydroxyphthalic acid to phthalazinone is sufficient to provide an a* value more negative than −2 (preferably more negative than −2.5) at an optical density of 1.2 as defined by the CIELAB Color System when the material has been imaged using a thermal print-head from 300 to 400° C. for less than 50 milliseconds (50 msec) and often less than 20 msec. In preferred embodiments, the molar ratio of phthalazinone is to hydroxyphthalic acid about 1:1 to about 3:1. More preferably the ratio is from about 2:1 to about 3:1.

In addition, the imaged material provides an image with an a* value more negative than −1 at an optical density of 1.2 as defined by the CIELAB Color System when the above imaged material is then stored at 70° C. and 30% RH for 3 hours.

Thermal solvents (or melt formers) can also be used, including combinations of such compounds (for example, a combination of succinimide and dimethylurea). Known thermal solvents are disclosed in U.S. Pat. No. 3,438,776 (Yudelson), U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender).

The thermographic materials can also include one or more image stabilizing compounds that are usually incorporated in a “backside” layer. Such compounds can include phthalazinone and its derivatives, pyridazine and its derivatives, benzoxazine and benzoxazine derivatives, benzothiazine-dione and its derivatives, and quinazoline-dione and its derivatives, particularly as described in U.S. Pat. No. 6,599,685 (Kong). Other useful backside image stabilizers include anthracene compounds, coumarin compounds, benzophenone compounds, benzotriazole compounds, naphthalic acid imide compounds, pyrazoline compounds, or compounds described in U.S. Pat. No. 6,465,162 (Kong et al.) and GB 1,565,043 (Fuji Photo).

The direct thermographic materials may also include one or more additional polycarboxylic acids (other than the hydroxyphthalaic acids noted above) and/or anhydrides thereof that are in thermal working relationship with the sources of reducible silver ions in the one or more thermographic layers. Such polycarboxylic acids can be substituted or unsubstituted aliphatic (such as glutaric acid and adipic acid) or aromatic compounds and can be present in an amount of at least 5 mol % ratio to silver. They can be used in anhydride or partially esterified form as long as two free carboxylic acids remain in the molecule. Useful polycarboxylic acids are described for example in U.S. Pat. No. 6,096,486 (noted above).

Binders

The non-photosensitive source(s) of reducible silver ions, the reducing agent(s), and any other thermographic layer additives are generally combined with one or more binders that are generally hydrophobic in nature. Thus, organic solvent-based formulations can be used to prepare the thermographic materials.

Examples of typical hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral, polyvinyl acetal, and polyvinyl formal) and vinyl copolymers (such as polyvinyl acetate and polyvinyl chloride) are particularly preferred. Particularly suitable hydrophobic binders are polyvinyl butyral resins that are available under the names MOWITAL® (Kuraray America, New York, N.Y.), S-LEC® (Sekisui Chemical Company, Troy, Mich.), BUTVAR® (Solutia, Inc., St. Louis, Mo.) and PIOLOFORM® (Wacker Chemical Company, Adrian, Mich.).

Hardeners for various binders may be present if desired. Useful hardeners are well known and include polyisocyanate compounds as described in EP 0 600 586 BI (Philip, Jr. et al.) and U.S. Pat. No. 6,313,065 (Horsten et al.), vinyl sulfone compounds as described in U.S. Pat. No. 6,143,487 (Philip, Jr. et al.) and EP 0 640 589 A1 (Gathmann et al.), aldehydes and various other hardeners as described in U.S. Pat. No. 6,190,822 (Dickerson et al.).

The binder(s) should be able to withstand the thermal imaging conditions described herein.

The polymer binder(s) is used in an amount sufficient to carry the components dispersed therein. Preferably, a binder is used at a level of from about 10% to about 90% by weight (more preferably at a level of from about 20% to about 70% by weight) based on the total dry weight of the layer.

It is particularly useful in the direct thermographic materials to use predominantly (more than 50% by weight of total binder weight) hydrophobic binders in both imaging and non-imaging layers on both sides of the support.

Support Materials

The direct thermographic materials comprise a polymeric support that is preferably a flexible, transparent film that has any desired thickness and is composed of one or more polymeric materials, depending upon their use. The supports are generally transparent (especially if the material is used as a photomask) or at least translucent, but in some instances, opaque supports may be useful. They are required to exhibit dimensional stability during thermal imaging and development and to have suitable adhesive properties with overlying layers. Useful polymeric materials for making such supports include polyesters, cellulose acetate and other cellulose esters, polyvinyl acetal, polyolefins, polycarbonates, and polystyrenes. Preferred supports are composed of polyesters or polycarbonates, such as polyethylene terephthalate film.

Opaque supports can also be used, such as dyed polymeric films and resin-coated papers that are stable to high temperatures. Support materials can contain various colorants, pigments, and dyes if desired. For example, the support can contain conventional blue dyes that differ in absorbance from colorants in the various frontside or backside layers as described in U.S. Pat. No. 6,248,442 (Van Achere et al.). Support materials may be treated using conventional procedures (such as corona discharge) to improve adhesion of overlying layers, or subbing or other adhesion-promoting layers can be used.

The support thickness can within the range of from about 2 to about 15 μm. Preferably, the support thickness is from about 4 to about 10 μm.

Protective Layer

The direct thermographic materials have two non-thermally sensitive protective layers on at least the imaging side of the support. These two protective layers are in direct contact with each other. The outermost (“first”) protective layer is farther from the support than the innermost (“second”) protective layer. The first protective layer is preferably the outermost layer of the thermographic material but it does not need to be if a desirable “slip” layer is applied over it. However, since the first protective layer contains predominantly all of the lubricants and matte agents used to facilitate transport during imaging, it can serve as the “slip” layer. The second protective layer is substantially free of lubricants and matte agents meaning that none are purposely incorporated therein but some may migrate from overlying or underlying layers.

By locating the lubricants, matte agents, and other components desired to facilitate transport in the outermost (or “first”) protective layer, less lubricant can be used and still achieve the desired “slip” properties.

In duplitized thermographic materials, the same or different first and second protective layers can be disposed on both sides of the support as long as the first protective layer is farther from the support on both sides thereof and the second protective layer on both sides of the support is substantially free of lubricants and matte agents.

A wide variety of materials are useful as binders in the two protective layers as described in U.S. Pat. No. 5,536,696 (Horsten et al.), U.S. Pat. No. 5,817,598 (Defieuw et al.), and U.S. Pat. No. 6,313,065 (noted above). However, it is desired that the first and second protective layer comprise the same organic solvent soluble polymer as the predominant binder, meaning that at least 50 weight % of all dry binder material in each layer is the same binder polymer. However, polyvinyl alcohols are excluded as the predominant binder polymers in each protective layer. More preferably, each protective layer comprises the same predominant organic solvent soluble binder polymer in an amount of at least 80 weight %, and most preferably in an amount of at least 95 weight %, based on total dry binder weight in each layer.

Examples of useful organic soluble binder polymers include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral, polyvinyl acetal, and polyvinyl formal) and cellulose acetate butyrate are particularly preferred. Particularly suitable hydrophobic binders are polyvinyl butyrals and cellulose acetate butyrates.

The amount of the binder(s) present in the first and second protective layer is generally in an amount of from about 50 to about 95 weight % of the total dry layer weight. The two protective layers can have the same or different amount of binder(s).

It is particularly desired that the outermost (“first”) protective layer have a dynamic coefficient of friction of less than 0.3 when the thermographic material is moved in contact and relative to an imaging means such as a thermal print-head. This “slip” property is usually provided by incorporating one or more lubricants into the outermost protective layer. Mixtures of lubricants such as one or more solid lubricants and one or more liquid lubricants can be used. The dynamic coefficient of friction can be measured as described in U.S. Pat. No. 5,817,598 (noted above).

Various lubricants are well known in the art that can be used in the first protective layer. Mixtures of different classes or types of lubricants can also be used.

More particularly, the first protective layer can comprise one or more lubricants from one or more of the following categories of compounds:

(a) solid polymers, each derived from one or more olefins and from one or more ethylenically unsaturated polymerizable carboxylic acids or esters or anhydrides thereof,

(b) branched α-olefin polymers,

(c) additional waxes other than compounds in categories of (a) and (b), and

(d) silicone oils.

Preferably, the protective layer includes one or more silicone oils and one or more compounds from any of the categories (a), (b), and (c), and more preferably at least one silicone oil and a wax from category (a) or (c).

Category (a) includes solid polymers derived from one or more olefins and from one or more ethylenically unsaturated polymerizable carboxylic acids or ester or anhydrides thereof. Suitable polymers include those described in U.S. Pat. No. 3,590,076 (Heintzelman et al.) that is incorporated herein by reference in its entirety. The number average molecular weight of the solid polymer is generally from about 300 to about 5000. Mixtures of these solid polymers can be used.

More particularly, the solid polymer is a polyolefin derived from one or more α-olefin monomers, preferably each having 2 to 8 carbon atoms. Ethylene and/or propylene are especially preferred monomers.

Suitable ethylenically unsaturated polymerizable carboxylic acid monomers are those having from 3 to 12 carbon atoms, and preferably from 4 to 5 carbon atoms. Monomers that are dicarboxylic acids and anhydrides thereof are preferred. These include maleic acid, ethyl maleic acid, propyl maleic acid, isopropyl maleic acid, fumaric acid, methylene malonic acid, glutaconic acid, itaconic acid, methyl itaconic acid, mesaconic acid, and citraconic acid and their mixtures, as well as the corresponding esters, anhydrides, and mixtures of such acids, esters and anhydrides. Isopropyl maleic acid, esters and anhydrides therefore are especially preferred.

For example, a category (a) polymer includes maleic anhydride polyethylene, maleic acid anhydride polypropylene, iso-propylmaleate polyethylene, and iso-propylmaleate polypropylene graft copolymers.

Category (b) lubricants are branched α-olefin polymers or mixtures thereof. The branched hydrocarbon typically has a number average molecular weight (as measured by vapor pressure osmometry) of at least 300, preferably at least 400, and more preferably at least 500. It typically has a number average molecular weight of no more than 10,000, preferably no more than 5,000, and more preferably no more than 3,000, although the molecular weight can be outside of these ranges. The branched hydrocarbon typically has a melting point (for crystalline materials) or a softening point (for amorphous or semi-crystalline materials) of at least 30° C., preferably at least 35° C., and more preferably at least 50° C., and typically has a melting point or softening point of no more than 120° C., although the melting point can be outside of these ranges. The degree of branching (or average number of branches per molecule) in the branched hydrocarbon typically is from about 4 to about 5, and typically is no more than about 15 although the degree of branching can be outside of these ranges. The branched hydrocarbon can be saturated or unsaturated, and can include cyclic moieties. In addition, oxidized hydrocarbons, such as polyethylene-based oxidized materials and microcrystalline-based oxidized materials can be used, as can unsaturated and branched hydrocarbon-like molecules using as a core cyclic compounds or dendrimer or arborols.

Also suitable are homopolymers and copolymers prepared from monomers of the formula R^{d}CH═CH₂ wherein R^{d} is a substituted or unsubstituted alkyl group having from 1 to 18 carbon atoms, and preferably from 3 to 12 carbon atoms, although the number of carbon atoms can be outside of these ranges. The polymerized α-olefin is also known as an olefin-derived hydrocarbon polymer or catalytically polymerized α-olefin.

These polymers can be prepared using for example, the polymerization process described in U.S. Pat. No. 4,060,569 (Woods et al.) that is incorporated herein by reference.

Some polymerized α-olefins are commercially available for example, from the Baker Petrolite Corporation (Sugar Land, Tex.) under the tradename VYBAR®, that is available as a solid (for example VYBAR® 103, VYBAR® 260) or liquid (for example VYBAR® 825).

Examples of suitable branched hydrocarbons include VYBAR® 253, a poly(α-olefin) having a number average molecular weight of about 520, a softening point of about 67° C. (measured by ASTM method D36) and a degree of branching of from about 5 to about 10. This polymer is based on an ethylene structure having pendant hydrocarbon side chains and is also referred to as a poly(α-olefin) or a poly(1-alkene). Also suitable for use are VYBAR® 103 having a number average molecular weight of about 4400, VYBAR® 260 having a number average molecular weight of about 2,600, and the VYBAR® X-series polymers, such as X-6044, X-6059, and X-6028. Also useful are oxidized hydrocarbons such as those available from Baker Petrolite Corp. as polyethylene-based oxidized materials and microcrystalline-based oxidized materials, such as the CARDIS® and PETRONAUBA® materials.

A particularly useful branched polyolefin is VYBAR® 103, CAS [68527-08-2] that is described as alkenes, macromonomers with greater than 10 carbon atoms that are α-polymerized and having a softening point of 74° C. (165.2° F.).

The third category (c) compounds include any suitable wax that will form a hydrophobic coating. Thus, animal, vegetable, mineral and synthetic waxes may be employed, as may be mixtures thereof.

Generally speaking, a wax is a substance that is a solid at ambient temperature and that has a low viscosity at just above its melting point. Typically, a wax is a substance having the following properties: (1) crystalline to microcrystalline structure, (2) capacity to acquire gloss when rubbed (as distinct from greases), (3) capacity to produce pastes or gels with suitable solvents or when mixed with other waxes, (4) low viscosity at just above the melting point. See Grant & Hackh's Chemical Dictionary (5^{th} Edition), page 628, hereby incorporated by reference. Waxes differ from fats in that fats are esters of trihydric lower alcohols.

The following components are illustrative types of both synthetically prepared and naturally occurring waxes:

Useful mineral waxes include but are not limited to paraffin (26-30 carbon atom aliphatic hydrocarbons), microcrystalline waxes (41-50 carbon atom branched chain hydrocarbons), oxidized microcrystalline waxes (hydrocarbons, esters, fatty acids), montan (waxing acids, alcohols, ester, and ketones), Hoechst waxes (oxidized montan wax), and ozokerite waxes (high molecular weight aliphatic and alkenyl hydrocarbons).

Useful vegetable waxes include but are not limited to, carnauba wax (complex alcohols and hydrocarbons), esparto, flax, and sugarcane waxes (fatty acid esters, aldehydes, esters, alcohols, hydrocarbons), and candelilla waxes (hydrocarbons, acids, esters, alcohols, and lactones).

Useful animal waxes include but are not limited to beeswax.

Useful synthetic waxes include but are not limited to polyolefins derived from one or more olefins.

One preferred additional wax is the fully saturated homopolymer of a low molecular weight polyethylene (such as a low molecular weight polyolefin), or copolymers of various alkene monomers that form polymers with a molecular weight at or below 3,000, a melting point below 130° C., and low melt viscosities. Applicable waxes could include POLYWAX® that is available from Baker Petrolite Corp. Another preferred wax is carnauba wax available as a dispersion from Elementis Specialties (Hightstown, N.J.) under the name SLIP-AYD® SL 508.

POLYWAX® is a linear polyethylene wax. A particularly preferred wax is POLYWAX® 400, CAS [9002-88-4], described as polyethylene homopolymer with weight average molecular weight of about 450 and a melting point of 81° C. (177.8° F.). Additional information on this material can be found at the website for POLYWAX® 400:

<http:hwww.bakerhughes.con>bakerpetrolite/polymers/ethylene_homopolymers.htm >.

In preferred embodiments, component (c) is a microcrystalline wax, carnauba wax, petronauba wax, paraffin wax, candelilla wax, or a linear low molecular weight polyethylene.

Silicone oils useful in category (d) include poly(diphenyl-phenylmethylsiloxane), poly(diphenylsiloxane), poly(methylethylsiloxane), poly(methylbutylsiloxane), poly(methylhexylsiloxane), and polydimethylsiloxane. Silicone oils can also possess a variety of terminating groups, including trimethylsilyl, distearate, perfluorooctadecyl, and aminopropyl. Particularly preferred silicone oils are aminopropyl terminated poly(dimethylsiloxane)s that are available from Gelest, Inc. (Morrisville, Pa.).

The first layer can contain additional lubricants such as poly(alcohols) and diols as described in U.S. Pat. No. 2,960,404 (Milton et al.), fatty acids or esters as described in U.S. Pat. No. 2,588,765 (Robijns) and U.S. Pat. No. 3,121,060 (Duane), and silicone resins as described in GB 955,061 (DuPont).

The total amount of lubricants in the protective layer is generally of from about 0.01 to about 1.5 g/m² and preferably from about 0.1 to about 0.5 g/m².

The first protective layer can also contain matting agents (organic or inorganic particles) such as particles of starch, titanium dioxide, zinc oxide, silica, and calcium carbonate, and polymeric beads including beads of the type described in U.S. Pat. No. 2,992,101 (Jelley et al.) and U.S. Pat. No. 2,701,245 (Lynn). The matting agents can be composed of any useful material and may have an average size in relation to the protective layer thickness that enables at least some of them to protrude through the outer surface of the protective layer, as described for example, in U.S. Pat. No. 5,536,696 (noted above). If matting agents are present, they generally comprise from about 0.2 to about 10 dry weight % of the protective layer.

Both the first and second protective layers can also contain pigments, “thermomeltable” particles, reinforcing agents, antistatic agents, conductive agents, coating aids, and tinting agents if desired.

Polymeric fluorinated surfactants may also be useful in the first protective layer as described in U.S. Pat. No. 5,468,603 (Kub).

In addition the first or second protective layer can contain nanometer size particles as reinforcing agents. Such particles are described in for example, in U.S. Patent Application Publication 2004/0198602 (Pham) that is incorporated herein by reference.

In general, the first protective layer has a dry thickness of from about 0.1 to about 5 μm, preferably from about 0.3 to about 3 μm, and more preferably, from about 1 to about 2 μm. The second protective layer generally has a dry thickness of from about 0.1 to about 5 μm, preferably from about 0.5 to about 4 μm, and more preferably, from about 1 to about 3 μm. The ratio of dry thickness of the first protective layer to the second protective layer is generally from about 1:20 to about 3:1 and preferably from about 1:10 to about 2:1.

In preferred embodiments, the first and second protective layers are the only layers disposed over the thermographic layer(s). However, intermediate barrier layers or interlayers can be interposed between the thermographic layer(s) and the second protective layer. Generally, there is no layer between the first and second protective layers.

If desired, the first or second protective layers, or both, can include one or more polyisocyanate crosslinking agents to “harden” the layer(s). Useful polyisocyanate crosslinking agents are described for example in U.S. Pat. No. 6,313,065 (Horsten et al.), U.S. Pat. No. 5,275,932 (Weigel et al.), and U.S. Pat. No. 5,578,548 (Bjork et al.), all incorporated herein by reference. Various catalysts such as tertiary amines can be used in combination with the polyisocyanates.

Thermographic Formulations and Constructions

An organic-based formulation for the thermographic emulsion layer(s) can be prepared by dissolving and dispersing the hydrophobic, organic solvent-soluble binders, and the source of non-photosensitive silver ions, the reducing agent, and other addenda in an organic solvent, such as toluene, 2-butanone (methyl ethyl ketone), acetone, or tetrahydrofuran (or mixtures thereof). First and second protective layer formulations described herein can be similarly formulated in the appropriate organic solvents with appropriate binders and other addenda if applicable.

The direct thermographic materials can be constructed of three or more layers on the imaging side of the support. Three-layer materials would include a single thermographic layer and the first and second protective layers. The single thermographic layer would contain the non-photosensitive source of reducible silver ions, the reducing agent, the binder, as well as other components such as toners, stabilizers, and coating aids.

Four-layer constructions can comprise two thermographic layers containing desired components and the first and second protective layers on the frontside of the materials.

In some preferred embodiments, the direct thermographic materials have one or more thermographic layers and the first and second protective layers disposed on only one side of the polymeric support, and one or more non-light sensitive layers are disposed on the backside of the polymeric support, at least one of those backside layers comprising an antistatic agent.

Layers to reduce emissions from the film may also be present, including the polymeric barrier layers described in U.S. Pat. No. 6,352,819 (Kenney et al.), U.S. Pat. No. 6,352,820 (Bauer et al.), U.S. Pat. No. 6,420,102 (Bauer et al.), and U.S. Pat. No. 6,746,831 (Hunt), and in U.S. Patent Application Publication 2004/0126719 (Geuens et al.), all incorporated herein by reference.

Mottle and other surface anomalies can be reduced in the materials of this invention by incorporation of a fluorinated polymer as described in U.S. Pat. No. 5,532,121 (Yonkoski et al.) or by using particular drying techniques as described in U.S. Pat. No. 5,621,983 (Ludemann et al.). Plasticizers may also be present in any layer of the thermographic material.

The direct thermographic materials may also usefully include a magnetic recording material as described in Research Disclosure, Item 34390, November 1992, or a transparent magnetic recording layer such as a layer containing magnetic particles on the underside of a transparent support as described in U.S. Pat. No. 4,302,523 (Audran et al.), incorporated herein by reference.

The direct thermographic materials can include one or more conductive or antistatic agents in any of the layers on either or both sides of the support. It is preferred that the conductive or antistatic layer be a non-light sensitive layer and be disposed on the backside of the support and especially where it is buried or underneath one or more other layers such as backside protective layer(s). Such backside layers typically have a water electrode resistivity (WER) of about 10⁵ to about 10¹² ohm/sq. This technique is described in R. A. Elder Resistivity Measurements on Buried Conductive Layers, EOS/ESD Symposium Proceedings, Lake Buena Vista, Fla., 1990, pp. 251-254, [EOS/ESD stands for Electrical Overstress/Electrostatic Discharge].

Typical conductive or antistatic agents include metal oxides, soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), polythiophenes as described in U.S. Pat. No. 5,747,412 (Leenders et al.), electroconductive underlayers as described in U.S. Pat. No. 5,310,640 (Markin et al.), electronically-conductive metal antimonate particles as described in U.S. Pat. No. 5,368,995 (Christian et al.), and electrically-conductive metal-containing particles dispersed in a polymeric binder as described in EP 0 678 776 A1 (Melpolder et al.).

The preferred non-light sensitive backside layer is a buried antistatic layer comprising metal oxide particles or conductive polymer particles (such as polythiophene particles). Additional optional layers can also include an adhesion promoting layer, an antihalation layer, a layer containing a matting agent (such as silica), or a combination of such layers. Preferably, a single outermost protective layer disposed over the buried backside conductive layer performs several or all of the desired additional functions.

The preferred metal oxide particles are generally provided for formulation in inorganic colloidal or sol form in a suitable solvent such as water or a water-miscible solvent such as methanol or other low molecular weight alcohols. The inorganic metal oxide colloids include oxide colloids of zinc, magnesium, silicon, calcium, aluminum, strontium, barium, zirconium, titanium, manganese, iron, cobalt, nickel, tin, indium, molybdenum, or vanadium, or mixtures of these metal oxide colloids. The metal oxides can be doped with other metals such as aluminum, indium, niobium, tantalum or antimony. Tin oxides, antimony tin oxides, and metal antimonates are preferred.

Preferably, the buried backside conductive layer comprises non-acicular metal antimonate particles such as those described in U.S. Pat. No. 6,689,546 (LaBelle et al.), and in copending and commonly assigned U.S. Ser. No. 10/930,428 (filed Aug. 31, 2004 by Ludemann, LaBelle, Koestner, Hefley, Bhave, Geisler, and Philip) Ser. No. 10/930,438 (filed Aug. 31, 2004 by Ludemann, LaBelle, Philip, Koestner, and Bhave), Ser. No. 10/978,205 (filed Oct. 29, 2004 by Ludemann, LaBelle, Koestner, and Chen), Ser. No. 10/999,858 (filed Nov. 30, 2004 Ludemann, Koestner, LaBelle, and Philip), and Ser. No. 11/000,115 (filed Nov. 30, 2004 by Ludemann, LaBelle, Philip, and Geisler). All of the above patents and patent applications are incorporated herein by reference. Particularly useful backside conductive layers and their formulations are described in more detail below. Several conductive metal antimonates are commercially available from Nissan Chemical Industry, Ltd. (Japan) under the tradename CELNAX® 401M. The metal antimonate particles in the conductive layer are predominately (more than 50% by weight of total particles) in the form of non-acicular particles as opposed to “acicular” particles. By “non-acicular” particles is meant not needlelike, that is, not acicular. Preferably the metal antimonate is zinc antimonate (ZnSb₂O₆).

The conductive layer also includes one or more binder materials that are usually polymers that are generally soluble or dispersible in the organic solvents noted above. Polyvinyl acetals, polyesters, cellulosic ester polymers, and vinyl polymers such as polyvinyl acetate and polyvinyl chloride are particularly preferred, and the polyvinyl acetals, polyesters, and cellulosic ester polymers are more preferred. Blends of these various polymers can also be used to advantage in the conductive layer.

The conductive layer is generally coated out of one or more miscible organic solvents including, but not limited to, methyl ethyl ketone (2-butanone, MEK), acetone, toluene, tetrahydrofuran, ethyl acetate, ethanol, methanol, or any mixture of any two or more of these solvents. Alternatively, the conductive layer can be coated using aqueous solvents and hydrophilic binder or a polymer latex.

In addition to the conductive particles described above, other conductive materials may be present in a buried conductive backside layer or other backside layers. Such compositions include fluorochemicals that are described in U.S. Pat. No. 6,699,648 (Sakizadeh et al.) and U.S. Pat. No. 6,762,013 (Sakizadeh et al.). Both of these patents are incorporated herein by reference.

Layer formulations described herein can be coated by various coating procedures including wire wound rod coating, dip coating, air knife coating, curtain coating, slide coating, or extrusion coating using hoppers of the type described in U.S. Pat. No. 2,681,294 (Beguin). The formulations can be coated one at a time and dried before application of another layer. Preferably, two or more formulations can be coated simultaneously by coating the multiple layers on top of a first applied layer while that layer is still wet using the same or different coating fluids or solvent mixtures using the procedures described in U.S. Pat. No. 2,761,791 (Russell), U.S. Pat. No. 4,001,024 (Dittman et al.), U.S. Pat. No. 4,569,863 (Keopke et al.), U.S. Pat. No. 5,340,613 (Hanzalik et al.), U.S. Pat. No. 5,405,740 (LaBelle), U.S. Pat. No. 5,415,993 (Hanzalik et al.), U.S. Pat. No. 5,525,376 (Leonard), U.S. Pat. No. 5,733,608 (Kessel et al.), U.S. Pat. No. 5,849,363 (Yapel et al.), U.S. Pat. No. 5,843,530 (Jerry et al.), and U.S. Pat. No. 5,861,195 (Bhave et al.), and GB Patent 837,095 (Ilford). Simultaneous multiple layer slide coating is particularly preferred. A typical wet coating thickness for the emulsion layer can be from about 10 to about 200 μm, and the layer can be dried in forced air at a temperature of from about 20° C. to about 100° C. The coated materials can be dried in forced air at a temperature of from about 20° C. to about 100° C. It is preferred that the thickness of the layer be selected to provide maximum image densities greater than about 0.2, and more preferably, from about 0.5 to 5.0 or more, as measured by an X-rite Model 361/V Densitometer equipped with 301 Visual Optics.

It is preferred that the first and second protective layers described herein be applied simultaneously with and over the still wet thermographic layer(s). The first and second protective layer formulations contain the same predominant organic solvent soluble binder other than polyvinyl alcohol (such as cellulose acetate butyrate) as the predominant binder. This manufacturing technique can be readily used to control the components of the first and second layers, thereby keeping the lubricants and matte agents in the first protective layer only, and also controlling the relative thickness of each layer upon drying.

Layers to promote adhesion of one layer to another in thermo-graphic materials are also known, as described in U.S. Pat. No. 5,891,610 (Bauer et al.), U.S. Pat. No. 5,804,365 (Bauer et al.), and U.S. Pat. No. 4,741,992 (Przezdziecki). Adhesion can also be promoted using specific polymeric adhesive materials as described in U.S. Pat. No. 5,928,857 (Geisler et al.).

Layers to promote adhesion of various layers to the support are also useful. Thus, the thermographic materials can also include a non-light sensitive adhesive layer between the support and one or more thermographic layers on each side of the support that includes thermographic layers. This adhesion layer is sometimes called a “carrier” layer when the adhesion layer formulation is applied simultaneously with and “carries” the thermographic layer coating formulations onto the support. Details about such coating techniques and compositions of “carrier” layer formulations are provided in U.S. Pat. No. 6,436,622 (Geisler), incorporated herein by reference. Simultaneous multilayer coating using carrier layers is preferred in high-speed manufacturing processes. If the thermographic material is duplitized, the non-light sensitive adhesive layer can have the same or different composition and thickness on both sides of the support. For the remainder of this section, the term “carrier” layer will be used in reference to the non-light sensitive adhesion layer. In preferred embodiments, the carrier layer is the only layer between the support and the thermographic layers on either or both sides of the support. Thus, the carrier layer is directly disposed on the support without the use of additional primer or subbing layers and allows the support to be used in an “untreated” and “uncoated” form before the simultaneous application of the carrier layer with other layers.

Preferably, the carrier layer comprises a single-phase mixture of two or more different polymers that include a “first” polymer serving to promote adhesion of the carrier layer to the polymeric support, and a “second” polymer. In such embodiments, the first polymer can be a polyvinyl acetal, cellulosic polymer, polyester, polycarbonate, epoxy resin, rosin polymer, polyketone resin, vinyl polymer, or maleic anhydride ester copolymer, and the second polymer can be a polyvinyl acetal resin, cellulosic resin, vinyl polymer, or maleic anhydride-ester copolymer. More preferably, the first polymer is a polyester and the second polymer is a polyvinyl acetal such as polyvinyl butyral, or a cellulosic polymer such as cellulose acetate butyrate.

It is also desirable that the second polymer be compatible with the film-forming polymer binder(s) of the one or more thermographic layers. For example, the thermographic layers and the carrier layer independently can contain at least one polyvinyl acetal or cellulosic polymer binder.

Representative “second” polymers include polyvinyl acetals, cellulosic polymers, vinyl polymers (as defined above for the “first” polymer), acrylate and methacrylate polymers, and maleic anhydride-ester copolymers. The most preferred “second” polymers are polyvinyl acetals and cellulosic ester polymers (such as cellulose acetate, cellulose diacetate, cellulose triacetate, cellulose acetate propionate, hydroxymethyl cellulose, cellulose nitrate, and cellulose acetate butyrate). Polyvinyl butyral is a particularly preferred second polymer. Of course, mixtures of these second polymers can be used in the carrier layer. These second polymers are also soluble or dispersible in the organic solvents described above.

The weight ratio of “first” polymer to “second” polymer in the carrier layer is generally from about 1:9 to about 1:1, and preferably from about 1:9 to about 4:6. A most preferred polymer combination is of polyester and polyvinyl butyral having a weight ratio of about 3:7.

More preferably the carrier layer also comprises one or more polyisocyanate crosslinking agents dispersed within one or more hydrophobic crosslinkable polymer binders. Such crosslinking agents have at least two isocyanate groups that may or may not be blocked with groups that are readily displaced during the hardening or crosslinking action. The polyisocyanates can comprise aliphatic, cycloaliphatic, or aromatic groups, or a combination thereof. Aromatic polyisocyanates are preferred. Polyisocyanates are also intended to include “polymeric isocyanates” that are polymeric compounds having repeating isocyanate groups along the polymer backbone.

Further details of such polyisocyanates and their use in carrier layers are provided in copending and commonly assigned U.S. Ser. No. 11/______, (filed on even date herewith by Baird, Kenney, and Moose, entitled “Direct Thermographic Material with Crosslinked Carrier Layer” and having attorney Docket 88680/JLT), incorporated herein by reference.

The carrier layer is generally coated out of one or more miscible organic solvents including, but not limited to, methyl ethyl ketone (2-butanone, MEK), acetone, toluene, tetrahydrofuran, ethyl acetate, ethanol, methanol, or any mixture of any two or more of these solvents.

The carrier layer generally has a dry thickness of from about 0.005 to about 5 μm, and preferably from about 0.1 to about 1 μm.

Imaging/Development

The direct thermographic materials can be imaged in any suitable manner consistent with the type of material using any suitable source of thermal energy. The image may be “written” simultaneously with development at a suitable temperature using a thermal stylus, a thermal print-head, or a laser, or by heating the material (usually the first protective layer) as it is moved while in contact with a heat absorbing material. The thermographic materials may include a dye (such as an IR-absorbing dye) to facilitate direct development by exposure to laser radiation. The dye converts absorbed radiation to heat. Thermal development is carried out with the materials being in a substantially water-free environment and without application of any solvent to the materials.

Use as a Photomask

The direct thermographic materials are sufficiently transmissive in the range of from about 350 to about 450 nm in non-imaged areas to allow their use in a method where there is a subsequent exposure of an ultraviolet or short wavelength visible radiation sensitive imageable medium. For example, imaging the materials affords a visible image. The thermographic materials absorb ultraviolet or short wavelength visible radiation in the areas where there is a visible image and transmit ultraviolet or short wavelength visible radiation where there is no visible image. The materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate. Exposing the imageable material to the imaging radiation through the visible image in the thermographic material provides an image in the imageable material. This method is particularly useful where the imageable medium comprises a printing plate and the thermographic material serves as an imagesetting film.

Thus, the present invention provides a method for the formation of a visible image (usually a black-and-white image) by thermal imaging of the direct thermographic material.

The following examples are provided to illustrate the practice of the present invention and the invention is not meant to be limited thereby.

Materials and Methods for the Experiments and Examples:

All materials used in the following examples are readily available from standard commercial sources, such as Aldrich Chemical Co. (Milwaukee, Wis.) unless otherwise specified. All percentages are by weight unless otherwise indicated.

Many of the chemical components used herein are provided as a solution. The term “active ingredient” means the amount or the percentage of the desired material contained in a sample. All amounts listed herein are the amount of active ingredient added unless otherwise specified.

ALBACAR 5970 is a 1.9 μm precipitated calcium carbonate. It is available from Specialty Minerals, Inc. (Bethlehem, Pa.).

BUTVAR® B-79 is a polyvinyl butyral resin available from Solutia, Inc. (St. Louis, Mo.).

CERAMER® 67 is a wax of type (a) above and comprise maleic anhydride adducts with polyolefins. It is available from Baker Petrolite Corporation (Sugar Land, Tex.).

CAB 171-15 and CAB 381-20 are cellulose acetate butyrate resins available from Eastman Chemical Co. (Kingsport, Tenn.).

CELNAX® CX-Z401M is a 40% organosol dispersion of non-acicular zinc antimonate particles in methanol. It was obtained from Nissan Chemical America Corporation (Houston, Tex.).

DESMODUR® L-75 is a toluene diisocyanate available from Bayer Corporation (Pittsburgh, Pa.).

DMS-A3 1 is an aminopropyl terminated polydimethylsiloxane available from Gelest, Inc. (Morrisville, Pa.).

MEK is methyl ethyl ketone (or 2-butanone).

PARALOID® A-21 is an acrylic copolymer available from Rohm and Haas (Philadelphia, Pa.).

PIOLOFORM® BL-16 and LL-4140 are polyvinyl butyral resins available from Wacker Polymer Systems (Adrian, Mich.).

Sekisui S-LEC® KS-1 resins is a high Tg (glass transition temperature) resin prepared from polyvinyl alcohol and acetaldehyde. It is available from Sekisui Chemical Company (Troy, Mich.).

SYLOID® 74X6000 is a synthetic amorphous silica that is available from Grace-Davison (Columbia, Md.).

VITEL® PE 2700B LMW, PE 5833B, and PE 7915 are polyester resins available from Bostik, Inc. (Middleton, Mass.).

VYBAR® is a highly branched polyethylene wax available from Baker Petrolite Corporation (Sugar Land, Tex.).

Optical Densities were measured using an X-Rite Model 361IV Densitometer available from X-Rite Incorporated (Grandville, Mich.).

Color measurement such as L*, a*, and b* values were measured using a HunterLab UltraScan (Hunter Associates Laboratory, Inc., Reston, Va.). These values were determined using CIELAB standards described above.

### EXAMPLE 1

Preparation and Coating of Backside Layers:

All thermographic materials had a buried backside conductive “carrier” layer and an outermost backside layer.

Buried Backside Conductive Carrier Layer Formulation:

A buried backside conductive carrier layer formulation was prepared by mixing the following materials:

| | | |
|---|---|---|
| CELNAX ® CX-Z401M | 50.0 | parts |
| (containing 40% active solids) | | |
| MEK | 375 | parts |
| VITEL ® PE-2700B LMW | 4.39 | parts |
| CAB 381-20 | 17.5 | parts |

Outermost Backside Layer Formulation:

An outermost backside layer formulation was prepared by mixing the following materials:

| | |
|---|---|
| MEK | 87.2 parts |
| CAB 381-20 | 11.0 parts |
| SYLOID ® 74X6000 | 0.14 parts |

The buried backside conductive layer formulation and outermost backside layer formulation were coated onto one side of a 7 mil (178 μm) blue tinted poly(ethylene terephthalate) support. A precision automated multilayer slide coater equipped with an in-line dryer was used. The backside coatings were dried at approximately 85° C. for 5 minutes. The coating weight of the backside conductive layer was 0.05 g/ft² (0.54 g/m²) and that of the outermost backside layer was 0.4 g/ft² (4.3 g/m²).

Preparation of Frontside Thermographic Coatings:

Frontside Carrier Layer Formulation:

374.40 Grams of VITEL® PE5833B were dissolved in 11,185.20 g of MEK. To this solution was added 6.720 g PIOLOFORM® LL-4140, and the resulting solution was stirred for one hour. This was allowed to stand until the day of coating, at which time 416.00 g of DESMODUR® L-75 were added to the solution.

Silver Soap Homogenate Formulation:

A silver soap thermographic homogenate formulation was prepared with the following components.

| | | |
|---|---|---|
| MEK | 75.5 | parts |
| Silver Behenate | 24.0 | parts |
| PIOLOFORM ® BL-16 | 0.5 | parts |

The materials were mixed and homogenized by passing twice through a homogenizer at 5000 psi (352 kg/cm²). The materials were cooled between the two passes.

Thermographic Emulsion Formulation:

To 4,506.67 g of the silver behenate homogenate at 24.5% solids was added 4,856.80 g of MEK in a container. The container was placed in a water bath that maintained the temperature of the dispersion at 19.4° C. and was stirred at a rate that gave a slight vortex. After 15 minutes of stirring, a solution containing 9.10 g of tetrachlorophthalic acid and 72.80 g of 4-hydroxyphthalic acid dissolved in 520.00 g methanol was added. The resulting dispersion was stirred for 60 minutes. Next, 208.00 g of 1-(2H)-phthalazinone were added and stirred for 15 minutes. This was followed by 2,699.67 g of BUTVAR® B-79. The agitation was increased to maintain the vortex, and the resulting dispersion was stirred for one hour. The temperature of the water bath was adjusted to a setpoint of 12.8° C. and the dispersion was held overnight at this temperature without stirring. The following morning, 126.97 g of 2,3-dihydroxybenzoic acid were added with stirring.

Second Protective Layer Formulation:

The following formulation of the second protective layer was prepared.

| | | |
|---|---|---|
| MEK | 89 | Parts |
| CAB 171-15 | 9.625 | Parts |
| PARALOID ® A-21 | 1.375 | Parts |

First (Outermost) Protective Layer Formulation:

The following formulation of the first (outermost) protective layer was prepared.

| | | |
|---|---|---|
| MEK | 7,947.50 | g |
| CAB 171-15 | 1,251.58 | g |
| PARALOID ®A-21 | 170.72 | g |

To this solution was added a dispersion of 95.15 g of ALBACAR® 5970 in 697.73 g of MEK. After stirring for 15 minutes, 563.20 g of a 20% solids dispersion of CERAMER 67 in MEK was added with stirring and the formulation was stirred for another 15 minutes. A solution of 19.80 g of DMS-A31 in 254.54 g of MEK was then added and stirred for an additional 15 minutes. The resulting first protective layer formulation contained 15.0% solids.

All frontside layer formulations were simultaneously applied to the previously backside-coated poly(ethylene terephthalate) support using a precision multilayer coater with an in-line dryer. The dried coating weight of the carrier layer was 0.05 g/ft² (0.54 g/m², while the emulsion layer was 1.55 g/ft² (16.7 g/m²). The coating weights of the protective layers were varied as follows:

TABLE I

| | | Coating | Coating | |
|---|---|---|---|---|
| | Comparative | Weight | Weight | Total |
| | (C) or | First | Second | Lubricant |
| | Inventive | Protective | Protective | Coating |
| Sample | (I) | Layer | Layer | Weight |
| 1-1-C | Comparative | 4.31 g/m² | — | 0.419 g/m² |
| 1-2-I | Inventive | 0.65 g/m² | 3.66 g/m² | 0.063 g/m² |
| 1-3-I | Inventive | 1.40 g/m² | 2.91 g/m² | 0.136 g/m² |
| 1-4-I | Inventive | 2.15 g/m² | 2.15 g/m² | 0.209 g/m² |
| 1-5-I | Inventive | 3.23 g/m² | 1.08 g/m² | 0.314 g/m² |

Evaluation of Samples

Thermographic materials of Samples 1-1 to 1-5 were tested to determine the force needed to transport the materials past a thermal print-head array.

A sample of each material was nipped between an 18 mm diameter rubber roller driven by a stepper motor and a Kyocera 12 dot/mm thermal print-head. The back of the thermal print-head was attached to a heat sink maintained at 35° C. The front of the thermal print-head was in contact with the protective layer on the “frontside” of the sample with a force of 54.5 Newtons pushing it against the rubber roller.

The imaging electronics were activated causing the sample to be drawn between the print-head and roller. Each dot was made over a period of 17.1 milliseconds (msec) by a series of pulses of a resistive element in the print-head array. Each pulse was 67 μsec long and consisted of 64 μsec “on” and 3 μsec “off”. By varying the number of pulses over 17.1 msec the density of each dot can be controlled. A stepped density (step wedge) was generated by incrementally increasing the number of pulses/dot from 85 to 255 (Dmin to Dmax). The voltage supplied to the print-head was approximately 14.5 Volts. This gave a maximum total energy of approximately 1.45 mJ/dot.

The test pattern consisted of a series of wide bars followed by a series of narrow bars. An initial wide bar of high density (Dmax) was printed to warm up the print-head followed by a second wide bar at low density (Toe density). The test pattern continued with a third wide bar at high density (Dmax) followed by a fourth wide bar at minimum density (Dmin). This was followed by a series of thin bars of alternating Dmax and Dmin.

As each area test pattern of given density is generated, the force required to draw the sample through the print nip was measured with a MCRT Torquemeter [Model 3-08T(16-1), 160 oz-in (1.13 N-m) range] obtained from S. Himmelstein and Co. (Hoffman Estates, Ill.). Torque data was recorded for Dmin, Toe, and Dmax density as noted above.

Toe Density Force is the average force reading within the first wide low density bar. Dmax Force is the average force reading within the second wide Dmax bar. Dmin Force is the force reading of the wide bar at Dmin following the second Dmax bar. Low force values, as well as similar force values across all density patches are desired in order to maintain even contact of the print-head to the thermographic material. It is desirable for the force values to be less than 3.5 pounds (15.6 N).

TABLE II below shows the force gauge testing results for various outermost protective layer coatings. All Samples meet the force requirements of less than 3.5 pounds (15.6 N) and show that a significant reduction in lubricant coating weight can be obtained while meeting the force requirement of 3.5 pounds (15.6 N).

TABLE II

| | Comparative (C) | Dmin Force | | Toe Density Force | | Dmax Force | | |
|---|---|---|---|---|---|---|---|---|
| Sample | or Inventive (I) | Pounds | (Newtons) | Pounds | (Newtons) | Pounds | (Newtons) | Haze |
| 1-1-C | Comparative | 2.21 | 9.83 | 2.14 | 9.52 | 1.22 | 5.43 | 36.3% |
| 1-2-I | Inventive | 2.59 | 11.52 | 2.32 | 10.32 | 1.39 | 6.18 | 29.3% |
| 1-3-I | Inventive | 2.4 | 10.68 | 2.31 | 10.28 | 1.33 | 5.92 | 31.2% |
| 1-4-I | Inventive | 2.31 | 10.28 | 2.21 | 9.83 | 1.24 | 5.52 | 33.1% |
| 1-5-I | Inventive | 2.27 | 10.1 | 2.21 | 9.83 | 1.23 | 5.47 | 35.8% |

### EXAMPLE 2

Backside conductive layers as well as frontside layers were prepared substantially as described in Example 1. The protective layer coating weights were used in this Example are shown below in TABLE III.

Samples were printed and evaluated as described above in Example 1. The force needed to transport the materials past a thermal print-head during printing are shown below in TABLE IV. In addition, the haze decreases substantially using this method while the lubricity is maintained

TABLE III

| | | Coating | Coating | |
|---|---|---|---|---|
| | Comparative | Weight | Weight | Total |
| | (C) or | First | Second | Lubricant |
| | Inventive | Protective | Protective | Coating |
| Sample | (I) | Layer | Layer | Weight |
| 2-1-C | Comparative | 4.31 g/m² | — | 0.419 g/m² |
| 2-2-I | Inventive | 2.15 g/m² | 2.15 g/m² | 0.209 g/m² |
| 2-3-I | Inventive | 1.29 g/m² | 2.15 g/m² | 0.126 g/m² |
| 2-4-I | Inventive | 0.65 g/m² | 1.94 g/m² | 0.063 g/m² |
| 2-5-I | Inventive | 1.29 g/m² | 1.29 g/m² | 0.126 g/m² |
| 2-6-I | Inventive | 1.08 g/m² | 3.23 g/m² | 0.105 g/m² |

TABLE IV

| | Comparative (C) | Dmin Force | | Toe Density Force | | Dmax Force | | |
|---|---|---|---|---|---|---|---|---|
| Sample | or Inventive (I) | Pounds | Newtons | Pounds | Newtons | Pounds | Newtons | Haze |
| 2-1-C | Comparative | 2.10 | 9.34 | 2.03 | 9.03 | 1.46 | 6.49 | 37.4% |
| 2-2-I | Inventive | 1.96 | 8.72 | 1.92 | 8.54 | 1.45 | 6.45 | 32.5% |
| 2-3-I | Inventive | 2.25 | 10.01 | 2.06 | 9.16 | 1.46 | 6.49 | 30.9% |
| 2-4-I | Inventive | 2.54 | 11.30 | 2.26 | 10.05 | 1.5 | 6.67 | 30.1% |
| 2-5-I | Inventive | 2.48 | 11.03 | 2.27 | 10.10 | 1.59 | 7.07 | 31.7% |
| 2-6-I | Inventive | 2.23 | 9.92 | 1.92 | 8.54 | 1.69 | 7.52 | 30.9% |

### EXAMPLE 3

Backside conductive layers as well as frontside layers were prepared substantially as in Example 1. The protective layer coating weights used in this Example are shown below in TABLE V.

The thermographic materials of Samples 3-1 to 3-4 were tested to determine the force needed to transport the materials past a thermal print-head.

A sample of each material was transported to a 25 mm silicone rubber platen roller where it was nipped between the platen roller driven by a stepper motor and Kyocera 320 dot/in (12.6 dot/mm) thermal print-head at a maximum power of 0.095 W/dot. The back of the thermal print-head was attached to a fan-cooled heat sink. The front of the thermal print-head was in contact with the protective layer on the “frontside” of the sample with a force of 118 Newtons pushing it against the rubber roller.

The imaging electronics were activated causing the sample to be drawn between the print-head and roller. At the same time the resistive elements in the thermal print-head were pulsed across a line time of 6 msec. Duty cycle was set to produce a density of 0.01 OD units above base density at Dmin, 1.0 OD at mid density, and 3.1 OD at high density. The voltage supplied to the print-head was approximately 14.5 Volts. This gave a maximum total energy of approximately 1.45 mJ/dot.

The test pattern consisted of a series of wide bars followed by a series of narrow bars. An initial wide bar of high density (Dmax) was printed to warm up the print-head followed by a second wide bar at mid density (Dmid). The test pattern continued with a third wide bar at high density (Dmax) followed by a fourth wide bar at minimum density (Dmin). This was followed by a series of thin bars of alternating Dmax and Dmin.

As each area test pattern of given density is generated, the torque on the platen roller required to draw the sample through the print nip was measured with a MCRT non-contact Torquemeter [Model 29000T-156 (1-2) NFZ, 100 oz-in range] obtained from S. Himmelstein and Co. (Hoffman Estates, Ill.). Torque data was recorded for Dmin, Dmid, and Dmax density as noted above.

Mid Density Torque (Dmid) is the average torque reading within the first wide mid-density bar. Dmax Torque is the average torque reading within the second wide Dmax bar. Dmin Torque is the force reading of the wide bar at Dmin following the second Dmax bar. Low torque values, as well as similar torque values across all density patches are desired in order to maintain even contact of the print-head to the thermographic material. It is desirable for the torque values to be less than 35 oz-in, (0.25 Nm). The torque readings were obtained during printing are shown below in Table VI.

TABLE V

| | | Coating | Coating | |
|---|---|---|---|---|
| | Comparative | Weight | Weight | Total |
| | (C) or | First | Second | Lubricant |
| | Inventive | Protective | Protective | Coating |
| Sample | (I) | Layer | Layer | Weight |
| 3-1-C | Comparative | 4.31 g/m² | — | 0.419 g/m² |
| 3-2-I | Inventive | 2.15 g/m² | 2.15 g/m² | 0.209 g/m² |
| 3-3-I | Inventive | 1.29 g/m² | 1.29 g/m² | 0.126 g/m² |
| 3-4-I | Inventive | 1.29 g/m² | 2.15 g/m² | 0.126 g/m² |

TABLE VI

| | Comparative (C) | Dmin Torque | | Dmid Torque | | Dmax Torque | | |
|---|---|---|---|---|---|---|---|---|
| Sample | or Inventive (I) | oz-in | Newton-m | oz-in | Newton-m | oz-in | Newton-m | Haze |
| 3-1-C | Comparative | 22.1 | 0.156 | 21.8 | 0.154 | 21.3 | 0.151 | 38.0% |
| 3-2-I | Inventive | 22.0 | 0.155 | 22.0 | 0.155 | 21.8 | 0.154 | 33.7% |
| 3-3-I | Inventive | 21.8 | 0.154 | 21.2 | 0.150 | 22.2 | 0.157 | 33.6% |
| 3-4-I | Inventive | 22.1 | 0.156 | 21.8 | 0.154 | 21.3 | 0.151 | 34% |

Additional Experimentation-1:

This experiment demonstrates the improvement in image tone by incorporating a combination of 4-hydroxyphthalic acid and phthalazinone in a direct thermographic material.

Preparation of Frontside Thermographic Coatings:

Frontside Primer Layer Formulation:

A solution containing 15 weight % of VITEL® 7915 in MEK was coated onto a 7 mil (178 um) blue tinted polyethylene terephthalate support having the buried backside conductive layer prepared in Example 1. The support was dried in an oven at 85° C. for 4 minutes to form a primer layer for the thermo-graphic image-forming layer. The coating weight of the primer layer was 1.0 g/m².

Silver Soap Homogenate Formulation:

A silver soap thermographic homogenate formulation was prepared with the following components.

| Component | Amount | |
|---|---|---|
| MEK | 75.5 | parts |
| Silver Behenate | 24.0 | parts |
| PIOLOFORM ® BL-16 | 0.5 | parts |

The materials were mixed and homogenized by passing twice through a homogenizer at 5000 psi (352 Kg/cm²). The materials were cooled between the two passes.

Thermographic Emulsion Formulation:

Thermographic emulsion layer formulations were prepared by mixing the components shown below.

| | | | Mixing Time |
|---|---|---|---|
| Component | Amount (parts) | | (Minutes) |
| Silver behenate homogenate | 104 | parts | |
| (24%) in MEK | Amount to total | | 15 |
| | 300 | parts | |
| Acid (See TABLE VII) | 9.2 | mmol | 60 |
| in Methanol | 30 | parts | |
| 1(2H)-Phthalazinone | 4.8 | parts | 30 |
| Sekisui KS-1 Polyvinyl acetal | 62.3 | parts | 60 |
| 2,3-Dihydroxybenzoic acid | 2.93 | parts | 60 |
| Total | 300 | parts | |

Outermost Protective Layer Formulation:

Outermost protective layer formulations for Examples 1 and 2 were prepared by mixing the components shown below.

| | | |
|---|---|---|
| MEK | 79.11 | parts |
| ALBACAR ® 5970 | 0.83 | parts |
| CAB 171-15 | 10.81 | parts |
| PARALOID ® A-21 | 1.46 | parts |
| Lubricant Premix | 7.78 | parts |
| VYBAR ® 103 | 12.5 | parts |
| CERAMER ® 1608 | 12.5 | parts |
| PIOLOFORM ® BL 16 | 0.5 | parts |
| MEK | 74.5 | parts |

Preparation and Evaluation of Thermographic Materials:

Each of the thermographic emulsion formulations and protective overcoat formulation was dual-knife coated onto the primed 7 mil blue tinted polyethylene terephthalate support prepared above. A conventional, laboratory scale, dual-knife coater was used. Samples were dried in an oven at 185° F. (85° C.) for 7 minutes. The coating weight of the thermographic layer was approximately 15.3 g/m². The coating weight of the protective overcoat layer was 3.0 g/m².

The thermographic materials were imaged on a custom-built thermographic printer to determine the Dmax above which fall-off occurred.

A sample of each material was transported to a 25 mm silicone rubber platen roller where it was nipped between the platen roller driven by a stepper motor and Kyocera 320 dot/in (12.6 dot/mm) thermal print-head at a maximum power of 0.095 W/dot. The back of the thermal print-head was attached to a fan-cooled heat sink. The front of the thermal print-head was in contact with the protective layer on the “frontside” of the sample with a force of 118 Newtons pushing it against the rubber roller.

The imaging electronics were activated causing the sample to be drawn between the print-head and roller. At the same time the resistive elements in the thermal print-head were pulsed across a line time of 6 milliseconds. Duty cycle was set to produce a continuous tone wedge with an optical density (OD) of 0.01 OD above base density of 0.16 at Dmin, 1.0 OD at mid density, and greater than 3.0 OD at high density as well as 8 and 21 step wedges. The voltage supplied to the print-head was approximately 14.5 Volts. This gave a maximum total energy of approximately 1.45 mJ/dot.

The initial CIELAB a* and b* values of the imaged samples were measured at an optical density of 1.2 were measured using a Hunter Lab UltraScan Colorimeter. Samples were then subjected to accelerated ageing at 160° F. (71° C.) for 3 hours. As noted above, for thermographic materials it is desired that the a* and b* values be negative (“cold”) and remain so after aging.

The results, shown below in TABLE VII demonstrate that that only 4-hydroxyphthalic acid provides a negative a* value both before and after accelerated aging. The results also show that aromatic dicarboxylic acids have the desired more negative b* values than aliphatic dicarboxylic acids.

Similar results would be obtained using similarly constructed direct thermographic materials having dual protective layers as described herein.

TABLE VII
Effect of Acid on Image Tone and Tone Stability

| | | a* and b* at | | a* and b* at | |
|---|---|---|---|---|---|
| | | 1.2 Optical Density | | 1.2 Optical Density | |
| | | Before Aging | | After Aging | |
| Sample | Acid Compound | a* | b* | a* | b* |
| AE 1-1-Comparative | No acid | −2.14 | −5.41 | 0.15 | −4.89 |
| AE 1-2-Comparative | Glutaric acid | 1.55 | −6.08 | 3.03 | −4.85 |
| AE 1-3-Comparative | Adipic acid | −0.18 | −4.13 | 1.38 | −3.61 |
| AE 1-4-Comparative | Phthalic acid | 0.55 | −9.86 | 1.14 | −9.63 |
| AE 1-5-Comparative | 4-Methylphthalic acid | −0.91 | −9.77 | 1.23 | −9.79 |
| AE 1-6-Inventive | 4-Hydroxyphthalic acid | −2.65 | −8.13 | −1.16 | −8.67 |
| AE 1-7-Comparative | 4-Chlorophthalic acid | −0.66 | −9.23 | 1.12 | −10.17 |
| AE 1-8-Comparative | 4-Nitrophthalic acid | −0.83 | −7.70 | −0.01 | −8.39 |
| AE 1-9-Comparative | 4,5-Dichlorophthalic acid | −0.77 | −8.64 | 0.43 | −9.53 |

Additional Experimentation-2:

Another experiment demonstrates the improvement imaging speed by incorporating a combination of 4-hydroxyphthalic acid and phthalazinone in a direct thermographic material.

Preparation of Frontside Thermographic Coatings:

Frontside primer layer and outermost protective layer formulations were prepared in the same manner as described above in the previous experiment. Thermographic emulsion formulations were prepared as shown below.

Thermographic Emulsion Formulation:

Thermographic emulsion layer formulations were prepared by mixing the components shown below.

| | | | Mixing Time |
|---|---|---|---|
| Component | Amount (parts) | | (Minutes) |
| Silver behenate homogenate | 104 | parts | |
| (24%) in MEK | Amount to total | | 15 |
| | 300 | parts | |
| 4-Hydroxyphthalic acid | 1.68 | parts | 60 |
| in Methanol | 30 | parts | |
| 1-(2H)-Phthalazinone Compound | 27.4 | mmol | 30 |
| TABLE VIII | | | |
| Sekisui KS-1 Polyvinyl acetal | 62.3 | parts | 60 |
| 2,3-Dihydroxybenzoic acid | 2.93 | parts | 60 |
| Total | 300 | parts | |

TABLE VIII

| | Comparative/ | 1-(2H)-Phthalazinone | MEK |
|---|---|---|---|
| Sample | Inventive | Compound | Solubility |
| AE 2-1-C | Comparative | 1-(2H)-Phthalazinone | Yes |
| | | (control) | |
| AE 2-2-C | Comparative | 4-Phenyl-1-(2H)- | No |
| | | phthalazinone | |
| AE 2-3-C | Comparative | 4-(4-Bromophenyl)-1- | No |
| | | (2H)-phthalazinone | |
| AE 2-4-C | Comparative | 4-(4-Methoxyphenyl)-1- | No |
| | | (2H)-phthalazinone | |
| AE 2-5-C | Comparative | 4-(4-Chlorophenyl)-1- | No |
| | | (2H)-phthalazinone | |
| AE 2-6-C | Comparative | 5,7-Dimethoxy-1-(2H)- | No |
| | | phthalazinone | |
| AE 2-7-I | Inventive | 4-(4-Pentylphenyl)-1- | Yes |
| | | (2H)-phthalazinone | |
| AE 2-8-I | Inventive | 6,7-Dimethoxy-1-(2H)- | Yes |
| | | phthalazinone | |
| AE 2-9-I | Inventive | 4-(4-Cyclohexylphenyl)-1- | Yes |
| | | (2H)-phthalazinone | |

Preparation and Evaluation of Thermographic Materials:

Each of the thermographic emulsion formulations and protective overcoat formulation was dual-knife coated onto the primed 7 mil blue tinted polyethylene terephthalate support prepared above. A conventional, laboratory scale, dual-knife coater was used. Samples were dried in an oven at 185° F. (85° C.) for 7 minutes. The coating weight of the thermographic layer was approximately 15.3 g/m². The coating weight of the protective overcoat layer was 3.0 g/m².

Many of the 1-(2H)-phthalazinone compounds shown in TABLE VIII are not soluble in the formulation solvent and were coated as dispersions.

Samples of thermographic materials were imaged using either an Agfa DryStar 2000 thermographic printer or using the custom-built thermographic printer described above. The same test pattern was used with each machine to produce different image densities ranging from Dmin to Dmax greater than 3.0. The densities were again measured with the X-Rite Model 361/V densitometer. In addition, the relative energy required to achieve an optical density of 0.3 and 1.0 were determined. The sensitometric results, shown below in TABLES IX and X demonstrate that substituted phthalazinone compounds that are soluble in the thermographic formulation solvent (such as MEK) require less energy to achieve a given optical density thus providing “faster” thermographic materials when compared with unsubstituted phthalazinone. Because different thermal printers were used, the relative energy values reported in TABLES IX and X are not directly comparable.

Similar results would be obtained using similarly constructed direct thermographic materials having dual protective layers as described herein.

TABLE IX
Imaged Using an AGFA DryStar 2000 Thermographic Printer

| | | | | Relative | Relative |
|---|---|---|---|---|---|
| | | | | Energy | Energy |
| Sample | Compound | Dmin | Dmax | at 0.3 OD | at 1.0 OD |
| AE 2-1- | 1-(2H)- | 0.17 | 3.2 | 52 | 122 |
| Comparative | Phthalazinone | | | | |
| | (control) | | | | |
| AE 2-7- | 4-(4- | 0.17 | 3.6 | 29 | 82 |
| Inventive | Pentylphenyl)- | | | | |
| | 1-(2H)- | | | | |
| | phthalazinone | | | | |

TABLE X
Imaged Using a Custom Built Thermographic Printer

| | | | | Relative | Relative |
|---|---|---|---|---|---|
| | | | | Energy at | Energy at |
| Sample | Compound | Dmin | Dmax | 0.3 OD | 1.0 OD |
| AE 2-1- | 1-(2H)-Phthalazinone | 0.18 | 3.6 | 53 | 59 |
| Comparative | (control) | | | | |
| AE 2-8- | 6,7-Dimethoxy-1-(2H)- | 0.19 | 3.5 | 52 | 58 |
| Inventive | phthalazinone | | | | |
| AE 2-9- | 4-(4-Cyclohexylphenyl)- | 0.19 | 3.4 | 49 | 56 |
| IInventive | 1-(2H)-phthalazinone | | | | |

*The lower the energy the faster the thermographic material.

The invention has been described in detail with particular reference to certain preferred embodiments thereof, but it will be understood that variations and modifications can be effected within the spirit and scope of the invention.

1. A direct thermographic material comprising a polymeric support and having thereon one or more thermographic layers, and
disposed over said one or more thermographic layers, first and second protective layers comprising the same organic solvent soluble polymer other than polyvinyl alcohol as the predominant binder, said first protective layer being farther from said support than said second protective layer, and said first protective layer comprising one or more lubricants while said second protective layer is substantially free of lubricants.

2. The material of claim 1 that is a black-and-white thermographic material comprising a non-photosensitive source of reducible silver ions and a reducing agent dispersed in a hydrophobic, organic solvent soluble binder.

3. The material of claim 1 wherein said first or second protective layer, or both have been crosslinked by a polyisocyanate crosslinking agent.

4. The material of claim 1 wherein said first protective layer has a dry thickness of from about 0.1 to about 5 μm and said second protective layer has a dry thickness of from about 0.1 to about 5 μm, and the ratio of dry thickness of said first protective layer to said second protective layer is from about 1:20 to about 2:1.

5. The material of claim 1 wherein said predominant binder in said first and second protective layer is cellulose acetate butyrate or polyvinyl butyral.

6. The material of claim 1 wherein said first protective layer is the outermost layer and has a dynamic coefficient of friction of less than 0.3 when moving in contact with a thermal print-head.

7. The material of claim 1 wherein said first and second protective layers are the only layers disposed over said one or more thermographic layers.

8. The material of claim 1 wherein said first protective layer comprises one or more lubricants from one or more of the following categories of compounds:
(a) solid polymers, each derived from one or more olefins and from one or more ethylenically unsaturated polymerizable carboxylic acids or esters or anhydrides thereof,
(b) branched α-olefin polymers,
(c) additional waxes other than compounds in categories of (a) and (b), and
(d) silicone oils.

9. The material of claim 1 wherein said thermographic layer comprises a mixture of one or more hydroxyphthalic acids and one or more phthalazinone compounds.

10. The material of claim 9 wherein said one or more hydroxyphthalic acids has a hydroxy group in the 4-position and carboxy groups in the 1- and 2-positions.

11. The material of claim 1 that is duplitized and has the same or different one or more thermographic layers and first and second protective layers on both sides of said polymeric support.

12. The material of claim 1 wherein said one or more thermographic layers and said first and second protective layers are disposed on only one side of said polymeric support, and one or more non-light sensitive layers are disposed on the backside of said polymeric support, at least one of said backside layers comprising an antistatic agent.

13. The material of claim 12 wherein at least one of said non-light sensitive backside layers is a buried antistatic layer comprising metal oxide particles or electronically conductive polymer particles.

14. The material of claim 1 further comprising an adhesive promoting layer disposed between said support and said one or more thermographic layers.

15. A black-and-white direct thermographic material comprising a polyester support and having on only one side thereof:
a thermographic layer comprising a non-photosensitive source of reducible silver ions that includes at least highly crystalline silver behenate and a reducing agent for producing a silver image, all distributed in a film-forming polyvinyl acetal, polyvinyl butyral, or cellulosic polymer binder,
disposed directly over said thermographic layer, first and second protective layers comprising cellulose acetate butyrate as the predominant binder, said first protective layer being farther from said support than said second protective layer, and said first protective layer comprising one or more lubricants and matte particles while said second protective layer is substantially free of lubricants, and said first protective layer is the outermost layer,
wherein said first protective layer has a dry thickness of from about 0.3 to about 3 μm and said second protective layer has a dry thickness of from about 0.5 to about 4 μm, and the ratio of dry thickness of said first protective layer to said second protective layer is from about 1:10 to about 2:1.

16. A method of providing a visible image comprising imaging the thermographic material of claim 1 with a thermal imaging source.

17. The method of claim 16 wherein said thermal imaging source is a thermal print-head.

18. The method of claim 16 wherein said visible image is used for a medical diagnosis.

19. A method for preparing a direct thermographic material comprising:
A) applying one or more thermographic formulations onto a polymeric support to provide one or more thermographic layers, and
B) applying over said one or more thermographic layers, first and second protective layer formulations comprising the same organic solvent soluble polymer other than polyvinyl alcohol as the predominant binder, to provide first and second protective layers, said first protective layer being farther from said support than said second protective layer, and said first protective layer comprising one or more lubricants while said second protective layer is substantially free of lubricants.

20. The method of claim 19 wherein said first and second protective layer formulations comprise cellulose acetate butyrate as the predominant binder, and said protective layer formulations are applied simultaneously with the first protective layer being the outermost layer in said material.
